(19) United States
(12) Patent Application Publication
(10) Pub. No.: US 2020/0099059 A1
(43) Pub. Date: Mar. 26, 2020

(54) POROUS ALUMINUM-FOIL ANODE AND METHOD FOR PREPARING SAME, AND LITHIUM SECONDARY BATTERY

(71) Applicant: REAL POWER INDUSTRIAL LIMITED COMPANY, Shenzhen (CN)

(72) Inventors: Yongbing TANG, Shenzhen (CN); Chengde XIE, Shenzhen (CN)

(21) Appl. No.: 16/475,268

(22) PCT Filed: Dec. 29, 2016
(86) PCT No.: PCT/CN2016/113282

§ 371 Date: Sep. 20, 2019

(51) Int. Cl. H01M 4/80; H01M 4/66

(52) U.S. Cl. CPC H01M 4/80; H01M 2004/027; H01M 4/661

(57) ABSTRACT

Disclosed are porous aluminum-foil anode, preparation method thereof and lithium secondary battery. The anode comprises a porous aluminum foil having a plurality of holes evenly arranged thereon, wherein a triangular region formed by connecting three centers of three adjacent holes defines a basic unit, in which a percentage of the area of the holes is in a range of 10% to 79%, and wherein a distance between an edge of the porous aluminum foil and an outermost hole is in a range of 0.1 mm to 10 mm. The porous aluminum foil anode can be applied in a lithium ion battery system in which the aluminum foil is used as both a current collector and an anode active material. It effectively solves the problem of battery expansion and decomposition of electrolyte, thereby improving charging and discharging efficiency, cyclability and safety performance of battery.

### FIELD OF THE INVENTION

The invention relates to the technical field of lithium secondary battery, in particular to porous aluminum foil anode, preparation method thereof and lithium secondary battery.

### BACKGROUND OF THE INVENTION

In 2016, the Shenzhen Institute of Advanced Technology of the Chinese Academy of Sciences made a breakthrough in the research of new high-efficiency batteries and developed a novel aluminum-graphite dual-ion battery, which has been published in Advanced Energy Materials (DOI: 10.1002/aenm.201502588). The novel high-efficiency battery system has aluminum foil as an anode plate. The aluminum foil acts as both a current collector and an anode active material. Due to the elimination of the use of conventional anode active material, such battery system has an improved specific energy density and a lower cost, thus having a good prospect of application. A problem with such battery system is that aluminum foil undergoes volume expansion during use and poor compatibility with electrolyte, which may impact on its charging and discharging efficiency, cyclability and safety performance.

### SUMMARY OF THE INVENTION

Accordingly, in a first aspect the present invention provides a porous aluminum foil anode that can be applied in a novel battery system in which the aluminum foil is used as both a current collector and an anode active material. It effectively solves the problem of battery expansion, effectively alleviates the decomposition of electrolyte caused by destruction of the solid electrolyte interphase during charging and discharging cycle of battery, and addresses the problem of short circuit caused by burrs on the aluminum foil piercing the separator, thereby improving charging and discharging efficiency, cyclability and safety performance of battery.

Specifically, in a first aspect the present invention provides a porous aluminum foil anode comprising porous aluminum foil having a plurality of holes evenly arranged thereon, wherein a triangular region formed by connecting three centers of three adjacent holes defines a basic unit, in which a percentage of the area of the holes is in a range of 10% to 79%, and wherein a distance between an edge of the porous aluminum foil and an outermost hole is in a range of 0.1 mm to 10 mm. In the porous aluminum foil anode of the present invention, the porous aluminum foil acts as both a current collector and an anode active material.

It is well known that active material for cathode and anode plates of lithium ion battery may be uniformly coated, at a specific ratio depending on their lithium storage capacities, on cathode and anode current collector by a coating method. Non-uniform coating of the cathode and anode active materials will lead to lithium metal deposition even lithium dendrites on the surface of anode, which may deteriorate the capacity and cyclability of battery and pose potential safety hazards to the battery. Therefore, the uniformity and consistency of the active material coating on the battery electrode plates are the key factors for the electrical performance and safety performance of battery. As such, in the fabrication of the lithium battery, it is necessary to strictly control the uniformity of the active material coating of the cathode and anode plates. Similarly, for the novel lithium ion battery system in which the porous aluminum foil is used as both the current collector and the anode active material, it is also necessary to strictly control the uniformity of the porous aluminum foil, and thus the pore size and the pore distribution of the porous aluminum foil are indications of whether it is qualified as both anode active material and current collector. In the present invention, the triangular region formed by connecting three centers of three adjacent holes defines a basic unit, in which a percentage of the area of the holes is in a range of 10% to 79%, preferably 25%-60%. In some embodiments, percentages of the area of the holes in each basic unit are equal.

The area percentage of the holes in a basic unit determines the maximum extent to which the porous aluminum foil anode will expand due to the lithium intercalation, and thus it can be designed according to a predetermined percentage of area of current collector and that of active material in the predesigned battery. Specifically, intercalation of lithium ions into aluminum foil to form an aluminum-lithium alloy may cause the volume to expand by 97%. Therefore, the present invention is designed to have reserved space to take account of volume expansion during aluminum-lithium alloying process. In an exemplary pre-designed battery where 20% of the area of the basic unit of the porous aluminum foil anode is used for the active material and 20-60% for the current collector, a percentage of the area of the holes in the basic unit is 20% or above 20%, such as 20%-60%, thus providing reserved space for the volume expansion caused by the intercalation of lithium ions into aluminum foil to form an aluminum-lithium alloy.

After being cut into electrode plates, a current large-sized porous aluminum foil obtained by a machining process may have a large number of burrs left on the edge of the aluminum foil due to the destruction of the holes. When assembled into a battery, the aluminum foil burrs may pierce the separator and lead to a short circuit which affects battery performance. The invention is designed to have margins instead of holes at the edge of the porous aluminum foil anode so as to avoid the production of the burrs and improve the stability and safety of battery. In some embodiments, a distance between the edge of the porous aluminum foil and the outermost hole is optionally in a range of 2 mm to 5 mm.

In some embodiments, in the porous aluminum foil, an isosceles triangular region formed by connecting three centers of three adjacent holes in two adjacent rows defines a basic unit, and percentages of the area of the holes in each basic unit are equal. Optionally, spacing between any two adjacent holes in a row is equal, and spacing between any two adjacent holes in a column is equal.

Optionally, spacing between any two adjacent holes in a row is equal to spacing between any two adjacent holes in a column. Optionally, spacing between any two adjacent holes in a row is equal to spacing between any two adjacent rows.

Optionally, the size of the holes of the porous aluminum foil is in a range of 20 nm to 2 mm. Further, the size of the holes is in a range of 50 μm to 1.5 mm. Further, the holes are equal in size.

In some embodiments, the holes of the porous aluminum foil may have, but not limit to, a shape of circle, ellipse, square, rectangle, diamond, triangle, polygon, star, trefoil, or the like. The larger the side length of the hole, the more favorable the intercalation of lithium ions.

In the present invention, a carbon material layer is further provided on the surface of the porous aluminum foil, and the material of the carbon material layer comprises one or more of conductive carbon black, graphene, graphite sheet, carbon nanotube, and organic carbide. The organic carbide comprises a carbide of an organic substance that is carbonized at a temperature in a range of 200° C. to 700° C. Specifically, the organic carbide comprises one or more of a carbide of glucose, a carbide of sucrose, a carbide of citric acid, a carbide of polyvinylpyrrolidone, a carbide of polyvinyl alcohol, a carbide of polypropylene alcohol, and a carbide of phenolic resin, etc.

Optionally, the carbon material layer has a thickness in a range of 2 nm to 5 μm. Further, the carbon material layer has a thickness in a range of 200 nm to 3 μm.

The porous aluminum foil anode provided in the first aspect of the present invention has a plurality of holes which provide enough space for the volume expansion caused by the intercalation of lithium ions into aluminum foil to form an aluminum-lithium alloy, so that the anode will not expand, thereby solving the battery expansion. The invention is designed to have margins instead of holes at the edge of the porous aluminum foil anode so as to avoid the production of the burrs and improve the stability and safety of battery. The carbon material layer provided on the surface of the porous aluminum foil enables the electrolyte to form a stable solid electrolyte interphase on the surface of the porous aluminum foil anode during the charging and discharging, and effectively alleviates the decomposition of electrolyte caused by destruction of the solid electrolyte interphase during charging and discharging cycle of battery, thereby improving charging and discharging efficiency, cyclability and safety performance of battery.

In a second aspect the present invention provides a method for preparing a porous aluminum foil anode, comprising:
performing one or more processes selected from mechanical compression molding, chemical etching, laser cutting, plasma etching and electrochemical etching to obtain a porous aluminum foil and thus a porous aluminum foil anode,
wherein the porous aluminum foil has a plurality of holes arranged thereon, and
wherein a triangular region formed by connecting three centers of three adjacent holes defines a basic unit, in which a percentage of the area of the holes is in a range of 10% to 79%, and
wherein a distance between an edge of the porous aluminum foil and an outermost hole is in a range of 0.1 mm to 10 mm.

Specifically, the porous aluminum foil may be prepared by designing a surface density of the cathode plate according to requirements in terms of the type or capacity of battery, as well as the type, specific capacity, compaction density of the cathode material, etc., and designing the porosity and dimensions (length, width and thickness) of the anode plate of battery according to the lithium-aluminum alloy Li—Al substance with a specific capacity of 993 mAh/g formed by lithium ions and aluminum foil; and designing size, shape and distribution of the holes of the porous aluminum foil according to the porosity and dimensions of the anode plate. The porous aluminum foil can be prepared by a process of mechanical compression molding, chemical etching, plasma etching and electrochemical etching or any combination thereof, in accordance with the above-mentioned design parameters, and then purged with compressed air to remove the burrs.

In the present invention, in the porous aluminum foil, an isosceles triangular region formed by connecting three centers of three adjacent holes in two adjacent rows defines a basic unit, and percentages of the area of the holes in each basic unit are equal. Optionally, spacing between any two adjacent holes in a row is equal, and spacing between any two adjacent holes in a column is equal.

Optionally, spacing between any two adjacent holes in a row is equal to spacing between any two adjacent holes in a column. Optionally, spacing between any two adjacent holes in a row is equal to spacing between any two adjacent rows.

Optionally, the size of the holes of the porous aluminum foil is in a range of 20 nm to 2 mm. Further, the size of the holes is in a range of 50 μm to 1.5 mm. Further, the holes are equal in size.

In the present invention, the holes of the porous aluminum foil may have, but not limit to, a shape of circle, ellipse, square, rectangle, diamond, triangle, polygon, star, trefoil, or the like.

Optionally, a percentage of the area of the holes in each basic unit is in a range of 25%-60%.

Optionally, the distance between the edge of the porous aluminum foil and the outermost hole is in a range of 2 mm to 5 mm Thus, cutting a large-sized porous aluminum foil obtained by a machining process into electrode plates may not destruct the holes and thus avoid the production of a large number of burrs.

Optionally, the porous aluminum foil has a thickness in a range of 10 to 100 microns.

Optionally, a carbon material layer is further prepared on the porous aluminum foil, comprising the following steps:
coating a solution containing the carbon material to the surface of the porous aluminum foil, which is then dried to obtain a porous aluminum foil anode; alternatively,
coating a solution containing a precursor of the carbon material to the surface of the porous aluminum foil, which is then heat-treated in a furnace filled with an inert gas or a reducing gas for 0.5 to 6 hours to carbonize the carbon material precursor to obtain the porous aluminum foil anode comprising the porous aluminum foil and the carbon material layer arranged on the surface of the porous aluminum foil.

The material of the carbon material layer comprises one or more of conductive carbon black, graphene, graphite sheet, carbon nanotube, and organic carbide. The precursor of the carbon material comprises an organic substance that is carbonized at a temperature in a range of 200° C. to 700° C. Specifically, the organic substance comprises one or more of glucose, sucrose, citric acid, polyvinylpyrrolidone, polyvinyl alcohol, polypropylene alcohol and phenolic resin, etc. The heat treatment is carried out at a temperature in a range of 200 to 700° C. The heat treatment is carried out for 2-4 hours.

Optionally, the carbon material layer has a thickness in a range of 2 nm to 5 μm. Further, the carbon material layer has a thickness in a range of 200 nm to 3 μm.

The inert gas comprises argon gas, nitrogen gas or the like. The reducing gas may be hydrogen. The step of drying may be carried out at a temperature in a range of 80° C. to 100° C. for 2-6 hours.

The preparation method of the porous aluminum foil anode provided in the second aspect of the present invention is advantageously simple, inexpensive and applicable to industrial production.

In a third aspect the present invention provides a lithium secondary battery, comprising a cathode plate, an electrolyte, a separator, and an anode plate which is a porous aluminum foil anode according to the first aspect of the present invention. The porous aluminum foil anode comprises a porous aluminum foil having a plurality of holes evenly arranged thereon. A triangular region formed by connecting three centers of three adjacent holes defines a basic unit, in which a percentage of the area of the holes is in a range of 10% to 79%. A distance between an edge of the porous aluminum foil and an outermost hole is in a range of 0.1 mm to 10 mm. The porous aluminum foil acts as both a current collector and an anode active material in the porous aluminum foil anode.

As for the lithium secondary battery according to the present invention, 20-60% of the area of the basic unit of the porous aluminum foil anode is used for the current collector and 1-40% for the active material.

Optionally, a percentage of the area of the holes in the basic unit is in a range of 25-60%. Optionally, the distance between the edge of the porous aluminum foil and the outermost hole is in a range of 2 mm to 5 mm.

In the present invention, in the porous aluminum foil, an isosceles triangular region formed by connecting three centers of three adjacent holes in two adjacent rows defines a basic unit, and percentages of the area of the holes in each basic unit are equal. Optionally, spacing between any two adjacent holes in a row is equal, and spacing between any two adjacent holes in a column is equal.

Optionally, spacing between any two adjacent holes in a row is equal to spacing between any two adjacent holes in a column. Optionally, spacing between any two adjacent holes in a row is equal to spacing between any two adjacent rows.

Optionally, the size of the holes of the porous aluminum foil is in a range of 20 nm to 2 mm. Further, the size of the holes is in a range of 50 μm to 1.5 mm. Further, the holes are equal in size.

In the present invention, the holes of the porous aluminum foil may have, but not limit to, a shape of circle, ellipse, square, rectangle, diamond, triangle, polygon, star, trefoil, or the like.

Optionally, the porous aluminum foil has a thickness in a range of 10 to 100 microns.

In the present invention, a carbon material layer is further provided on the surface of the porous aluminum foil, and the material of the carbon material layer comprises one or more of conductive carbon black, graphene, graphite sheet, carbon nanotube, and organic carbide. The organic carbide comprises a carbide of an organic substance that is carbonized at a temperature in a range of 200° C. to 700° C. Specifically, the organic carbide comprises one or more of a carbide of glucose, a carbide of sucrose, a carbide of citric acid, a carbide of polyvinylpyrrolidone, a carbide of polyvinyl alcohol, a carbide of polypropylene alcohol, and a carbide of phenolic resin, etc.

Optionally, the carbon material layer has a thickness in a range of 2 nm to 5 μm. Further, the carbon material layer has a thickness in a range of 200 nm to 3 μm.

In the present invention, the cathode plate includes a cathode active material which may be selected from graphite or a lithium-ion cathode material, such as lithium iron phosphate, lithium cobaltate, lithium titanate or the like. That is, the lithium secondary battery may be a conventional lithium ion battery or an aluminum-graphite dual-ion battery. In the case of an aluminum-graphite dual-ion battery, the cathode plate includes graphite, that is, graphite is used as a cathode active material.

In some embodiments, the electrolyte and the separator may be selected from conventional electrolyte and separator for lithium ion battery.

The lithium secondary battery having a well-designed porous aluminum foil acting as both a current collector and a anode active material provided by the third aspect of the present invention has good cyclability and safety performance.

The advantages of the invention will be set forth in the description. Some of the advantages will be apparent from the description or the implementation of the embodiments.

### BRIEF DESCRIPTION OF THE DRAWINGS

FIG. 1 shows the structure of a porous aluminum foil according to Example 1 of the present invention.

FIG. 2 shows the structure of a porous aluminum foil according to Example 2 of the present invention.

FIG. 3 shows the structure of a porous aluminum foil according to Example 64 of the present invention.

### DETAILED DESCRIPTION OF THE INVENTION

The following are preferred embodiments of the present invention. It should be noted that various other changes and modifications can be made without departing from the scope of the disclosure. Accordingly, it is therefore intended that the present invention covers all such changes and modifications.

The embodiments of the present invention will be described below in Examples. The embodiments of the present invention are not limited to the following Examples. Various other changes and modifications can be made without departing from the scope of the disclosure.

### Example 1

A method for preparing a porous aluminum foil anode comprises the following steps.

(1) A 50-micron-thick aluminum foil was made into porous aluminum foil by mechanical molding, in accordance with the design parameters including: a percentage of the area of the holes in a basic unit of 25%, a hole size of 1 mm, a circular hole, and a distance from the edge of the outermost hole and the edge of the aluminum foil of 2 mm. The porous aluminum foil was then purged with compressed air to remove the burrs.

(2) Subsequently, the porous aluminum foil was immersed in an aqueous solution containing 20% polyvinylpyrrolidone for 10 minutes, and then placed in a furnace filled with nitrogen and the temperature was elevated at a rate of 3° C./min to 400° C. The porous aluminum foil was subjected to carbonization at 400° C. for 4 hours to obtain a porous aluminum foil anode.

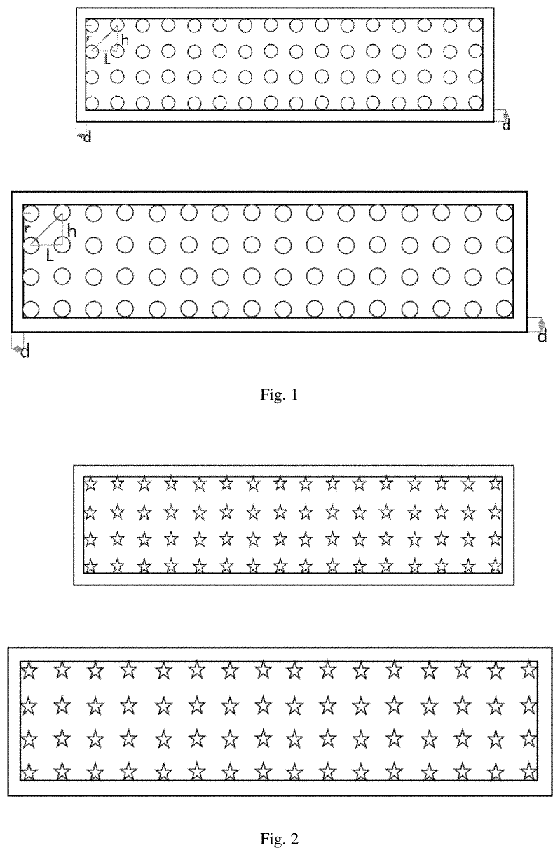

FIG. 1 shows the structure of a porous aluminum foil according to Example 1 of the present invention. In the figure, d denotes the distance between the edge of the outermost hole and the edge of the aluminum foil (2 mm); r denotes the radius of the circular hole, and an isosceles triangular region formed by connecting three centers of three adjacent holes defined a basic unit, in which the area of the holes (πr²)/2 accounts for 25% of the total area of the triangular region (h*L)/2. In this embodiment, the holes are arranged in a rectangular array, in which spacing between any two adjacent holes in a row is equal, and spacing between any two adjacent holes in a column is equal, and spacing between any two adjacent holes in a row is equal to spacing between any two adjacent holes in a column, and each row has an equal number of holes, and each column has an equal number of holes, and the holes are aligned and equal in size.

Preparation of Conventional Lithium Ion Battery

A lithium iron phosphate cathode material having a specific capacity of 140 mAh/g and PVDF and conductive carbon black at a ratio of 95:3:2 were coated on aluminum foil to prepare a cathode plate. The preparation of the cathode plate was conducted and controlled by a current process technology. Then a full battery was assembled in an argon filled glove box from the porous aluminum foil anode, the above cathode, an electrolyte which was a mixed solution of 1 mol/L LiPF6 in ethylene carbonate (EC) and dimethyl carbonate (DMC) with a volume ratio of 1:1, and a separator of celgard 2400 polypropylene porous membrane to obtain a battery sample C1.

### Comparative Example 1 (Conventional Lithium Ion Battery)

A 50-micron-thick aluminum foil was immersed in an aqueous solution containing 20% polyvinylpyrrolidone for 10 minutes, and then the above porous aluminum foil was placed in a furnace filled with nitrogen, and the temperature was elevated at a rate of 3° C./min to 400° C. The porous aluminum foil was subjected to carbonization at 400° C. for 4 hours to obtain an aluminum foil anode. A lithium iron phosphate cathode material having a specific capacity of 140 mAh/g and PVDF and conductive carbon black at a ratio of 95:3:2 were coated on aluminum foil to prepare a cathode plate. The preparation of the cathode plate was conducted and controlled by a current process technology. Then a full battery was assembled in an argon filled glove box from the cathode plate, aluminum foil anode plate, an electrolyte which was a mixed solution of 1 mol/L LiPF6 in ethylene carbonate (EC) and dimethyl carbonate (DMC) with a volume ratio of 1:1, and a separator of celgard 2400 polypropylene porous membrane to obtain a battery sample C0.

### Examples 2-38

Examples 2-38 were conducted in accordance with Example 1 by adjusting the related parameters. The parameters and test results are shown in Table 1.

TABLE 1

| | | Designed | | Percentage | Proportion | Proportion | |
|---|---|---|---|---|---|---|---|
| | | capacity of | | of area of | of active | of current | Coating |
| Item | Cathode | cathode | Size (mm) | the holes (%) | material (%) | collector (%) | material |
| Ex. 1 | LFP | 140 | 1 | 25 | 25 | 50 | 20% polyvinyl- |
| | | | | | | | pyrrolidone |
| Ex. 2 | LFP | 140 | 2 | 30 | 30 | 40 | 30% glucose |
| Ex. 3 | LCO | 140 | 1 | 25 | 25 | 50 | 30% sucrose |
| Ex. 4 | LFP | 140 | [symbol] | 2 [symbol] | 32. [symbol] | 42.5 | / |
| Ex. 5 | LFP | 140 | 2 | 25 | 32. [symbol] | 42.5 | 30% glucose |
| Ex. 6 | LFP | 140 | 0.2 | 32. [symbol] | 32.5 | 35 | 30% glucose |
| Ex. 7 | LCO | 140 | 0.8 | 25 | 35 | 45 | 2% conductive |
| | | | | | | | carbon black |
| Ex. 8 | LCO | 140 | 0.5 | 25 | 35 | 40 | 20% polyvinyl- |
| | | | | | | | pyrrolidone |
| Ex. 9 | NCM | 160 | 0. [symbol] | 25 | 35 | 40 | 20% polyvinyl- |
| | | | | | | | pyrrolidone |
| Ex. 10 | NCM | 160 | 0.5 | 25 | 35 | 40 | 20% polyvinyl- |
| | | | | | | | pyrrolidone |
| Ex. 11 | LCO | 140 | 1.5 | 25 | 30 | 45 | 2% conductive |
| | | | | | | | carbon black |
| Ex. 12 | LFP | 140 | 1.2 | 25 | 32.5 | 42.5 | 20% glucose |
| Ex. 13 | LFP | 140 | 2 [symbol] 0 [symbol] | 10 | 40 | 50 | 10% polyacrylic |
| | | | | | | | alcohol |
| Ex. 14 | LFP | 140 | 0.0002 | 20 | 15 | 65 | 5% polyvinyl |
| | | | | | | | alcohol |
| Ex. 15 | LFP | 140 | 0.001 | 30 | 15 | [symbol] 5 | 15% phenolic resin |
| Ex. 16 | LFP | 140 | 0.0005 | 40 | 40 | 20 | 20% phenolic resin |
| Ex. 17 | LFP | 140 | 0.05 | 50 | 30 | 20 | 2% graphite sheet |
| Ex. 18 | LFP | 140 | 0.01 | 60 | 10 | 30 | 1% graphene |
| Ex. 19 | LCO | 140 | 5 [symbol] 0 [symbol] | 10 | 60 | 30 | 1.5% carbon |
| | | | | | | | nanotubes |
| Ex. 20 | LCO | 140 | 0.00 [symbol] | 20 | 55 | 25 | 10% citric acid |
| Ex. 21 | LCO | 140 | 0.001 | 30 | 45 | 25 | 15% polyacrylic |
| | | | | | | | alcohol |
| Ex. 22 | LCO | 140 | 0.02 | 40 | 40 | 20 | 20% polyvinyl |
| | | | | | | | alcohol |
| Ex. 23 | LCO | 140 | 0.05 | 50 | 30 | 20 | 25% polyvinyl |
| | | | | | | | alcohol |
| Ex. 24 | LCO | 140 | 0.0 [symbol] | 60 | 20 | 20 | 30% polyvinyl |
| | | | | | | | alcohol |
| Ex. 25 | LCO | 140 | 1.2 | 70 | 10 | 20 | 5% [symbol] |
| Ex. 26 | LCO | 140 | 2 | 75 | 1 | 20 | 2% citric acid |
| Ex. 27 | LCO | 140 | 0.005 | 75 | 5 | 20 | 2% sucrose |
| Ex. 28 | NCM | 160 | [symbol] 05 | 15 | 25 | 60 | 5% sucrose |
| Ex. 29 | NCM | 160 | 0.008 | 25 | 2 [symbol] | 50 | 30% sucrose |
| Ex. 30 | NCM | 160 | 0.001 | 3 [symbol] | 25 | 40 | 7.5% polyacrylic |
| | | | | | | | alcohol |
| Ex. 31 | NCM | 160 | 0.08 | 45 | 2 [symbol] | 30 | 2.3% polyacrylic |
| | | | | | | | alcohol |
| Ex. 32 | NCM | 160 | 0.08 | 35 | 2 [symbol] | 20 | 27.5% polyacrylic |
| | | | | | | | alcohol |
| Ex. 33 | NCM | 160 | 0.01 | 6 [symbol] | 15 | 20 | 7.5% polyvinyl |
| | | | | | | | alcohol |
| Ex. 34 | NCM | 160 | 1.8 | 75 | 5 | 20 | 20% citric acid |
| Ex. 35 | NCM | 160 | 2 | 15 | 60 | 25 | 25% citric acid |
| Ex. 36 | NCM | 160 | 0.00 [symbol] | 10 | [symbol] 0 | 40 | 30% citric acid |
| Ex. 37 | NCM | 160 | 1.1 | 10 | 45 | 45 | 15% polyvinyl |
| | | | | | | | alcohol |
| Ex. 38 | NCM | 160 | 0.7 | 30 | 30 | 40 | 15% glucose |
| Comparative | LFP | 140 | 0 | 0 | 25 | 75 | 20% polyvinyl- |
| Ex. 1 | | | | | | | pyrrolidone |

| | | | | | | Capacity |
|---|---|---|---|---|---|---|
| | Thickness | | | | Efficiency | retention |
| | of aluminum | Shape of | Distance* | Temperature | during the | after 500 |
| Item | foil (μm) | holes | (mm) | (° C.) | first cycles (%) | cycles(%) |
| Ex. 1 | [symbol] 0 | Circle | 3 | 400 | 90 | 94 |
| Ex. 2 | 60 | Star | 3 | 500 | 89 | 93 |
| Ex. 3 | [symbol] 0 | Oblique | 3 | 500 | 8 [symbol] .5 | 92 |
| | | diamond | | | | |
| Ex. 4 | 70 | Star | 3 | [symbol] 00 | [symbol] 8.5 | 90.5 |
| Ex. 5 | [symbol] 0 | Circle | 3 | 500 | 89 | 91 |
| Ex. 6 | 80 | Star | [symbol] | 450 | 89 | 93 |
| Ex. 7 | 40 | Square | 2 | 300 | 90 | 91 |
| Ex. 8 | 40 | Square | 2 | 450 | 89.5 | 91.5 |
| Ex. 9 | 40 | Square | 2 | 450 | 89 | 91.8 |
| Ex. 10 | 30 | Regular | 2 | 450 | 89 | 92 |
| | | hexagon | | | | |
| Ex. 11 | 40 | Regular | 2 | 300 | 90 | 91.5 |
| | | pentagon | | | | |
| Ex. 12 | 20 | Circle | 3 | [symbol] 00 | 89 | 91.5 |
| Ex. 13 | 40 | Diamond | 0.1 | 2 [symbol] 0 | 82 | 82.1 |
| Ex. 14 | 25 | Diamond | 0.5 | 200 | 85 | [symbol] 2.5 |
| Ex. 15 | 16 | Diamond | 1 | 200 | 87 | 93 |
| Ex. 16 | 40 | Diamond | 0.5 | 200 | 86 | 82 |
| Ex. 17 | [symbol] 0 | Diamond | 0.5 | 250 | 87 | 87.5 |
| Ex. 18 | [symbol] 8 | Diamond | 2 | 250 | 82 | 92.5 |
| Ex. 19 | 36 | Circle | 2 | 250 | 84 | 81.5 |
| Ex. 20 | 300 | Circle | 2 | 250 | 85.2 | 82.5 |
| Ex. 21 | 25 | Circle | 3 | 250 | 8 [symbol] .5 | 84 |
| Ex. 22 | 40 | Circle | [symbol] | 250 | 87 | 85 |
| Ex. 23 | 30 | Circle | 3 | 300 | 87.5 | 87 |
| Ex. 24 | 20 | Circle | 3 | 300 | 88 | 90 |
| Ex. 25 | [symbol] 0 | Circle | 1. [symbol] | 300 | 85 | 91.5 |
| Ex. 26 | 100 | Circle | 1.5 | 300 | 80 | 9 [symbol] |
| Ex. 27 | 20 | Circle | 1.5 | 350 | 82 | 93.5 |
| Ex. 28 | 30 | Circle | 1.5 | 350 | 83 | [symbol] 8 |
| Ex. 29 | 30 | Circle | 4.5 | 350 | [symbol] | 90 |
| Ex. 30 | 40 | Circle | 4.5 | 400 | 87.5 | 9 [symbol] |
| Ex. 31 | 50 | Circle | 4.5 | 400 | 88.5 | 92 |
| Ex. 32 | 50 | Square | 4.5 | 400 | 80 | 90.3 |
| Ex. 33 | 40 | Square | [symbol] | 600 | 8 [symbol] .2 | [symbol] |
| Ex. 34 | 16 | Square | 5 | [symbol] 00 | 8 [symbol] .5 | 9 [symbol] |
| Ex. 35 | 40 | Square | 5 | 600 | 86.5 | 86.3 |
| Ex. 36 | 20 | Square | [symbol] | 700 | 87 | 87.5 |
| Ex. 37 | 40 | Square | 5 | 700 | 89 | 8 [symbol] |
| Ex. 38 | 30 | Square | 5 | 700 | 90 | 89.5 |
| Comparative | [symbol] 0 | / | 0 | 400 | 78 | 80 |
| Ex. 1 | | | | | | |

(LFP = Lithium iron phosphate;
LCO = Lithium cobaltate;
NCM = Nickel cobalt manganese ternary material;
Distance* = distance between the edge of the hole and the edge of the electrode plate) [symbol]
indicates data missing or illegible when filed

### Example 39

A method for preparing a porous aluminum foil anode comprises the following steps.

(1) A 20-micron-thick aluminum foil was made into porous aluminum foil by mechanical molding, in accordance with the design parameters including: a percentage of the area of the holes in a basic unit of 25%, a hole size of 1 mm, a circular hole, and a distance from the edge of the outermost hole and the edge of the aluminum foil of 2 mm. The porous aluminum foil was then purged with compressed air to remove the burrs.

(2) Subsequently, the porous aluminum foil was immersed in an aqueous solution containing 20% polyvinylpyrrolidone for 10 minutes, and then placed in a furnace filled with an inert gas or a reducing gas and the temperature was elevated at a rate of 3° C./min to 400° C. The porous aluminum foil was subjected to carbonization at 400° C. for 4 hours to obtain a porous aluminum foil anode.

Preparation of Aluminum-Graphite Dual-Ion Battery

A graphite cathode material having a specific capacity of 100 mAh/g and PVDF and conductive carbon black at a ratio of 95:3:2 were coated on aluminum foil to prepare a cathode plate. The preparation of the cathode plate was conducted and controlled by a current process technology. Then a full battery was assembled in an argon filled glove box from the porous aluminum foil anode, the above cathode, an electrolyte which was a mixed solution of 4 mol/L LiPF6 in ethylene carbonate (EC) and dimethyl carbonate (DMC) with a volume ratio of 1:1+2% vinylene carbonate (VC), and a separator of celgard 2400 polypropylene porous membrane to obtain a battery sample C10.

### Comparative Example 2 (Aluminum-Graphite Dual-Ion Battery)

A 20-micron-thick aluminum foil was immersed in an aqueous solution containing 20% polyvinylpyrrolidone for 10 minutes, and the above porous aluminum foil was placed in a furnace filled with an inert gas or a reducing gas and the temperature was elevated at a rate of 3° C./min to 400° C. The porous aluminum foil was subjected to carbonization at 400° C. for 4 hours to obtain a carbon modified aluminum foil anode plate. A graphite cathode material having a specific capacity of 100 mAh/g and PVDF and conductive carbon black at a ratio of 95:3:2 were coated on aluminum foil to prepare a cathode plate. The preparation of the cathode plate was conducted and controlled by a current process technology. Then a full battery was assembled in an argon filled glove box from the cathode plate, the carbon modified aluminum foil which was used as an anode plate, an electrolyte which was a mixed solution of 4 mol/L LiPF6 in ethylene carbonate (EC) and dimethyl carbonate (DMC) with a volume ratio of 1:1+2% vinylene carbonate (VC), and a separator of celgard 2400 polypropylene porous membrane to obtain a battery sample COO.

### Examples 40-63

Examples 40-63 were conducted in accordance with Example 39 by adjusting the related parameters. The parameters and test results are shown in Table 2.

TABLE 2

| | | Designed | | Percentage | Proportion | Proportion | |
|---|---|---|---|---|---|---|---|
| | | capacity of | | of area of | of active | of current | Coating |
| Item | Cathode | cathode | Size (mm) | the holes (%) | material (%) | collector (%) | material |
| Ex. 39 | graphite | 100 | 1 | 25 | 25 | 50 | 20% polyvinyl- |
| | | | | | | | pyrrolidone |
| Ex. 40 | graphite | 100 | 2 | 30 | 30 | 40 | 30% glucose |
| Ex. 41 | graphite | 100 | 1 | 25 | 25 | 50 | 30% sucrose |
| Ex. 42 | graphite | 100 | 2 | 25 | 32.5 | 42.5 | 30% glucose |
| Ex. 43 | graphite | 100 | 2 | 25 | 32.5 | 42.5 | / |
| Ex. 44 | graphite | 100 | 0.2 | 32.5 | 32.5 | 35 | 30% glucose |
| Ex. 45 | graphite | 100 | 0.8 | 25 | 35 | 45 | 2% conductive |
| | | | | | | | carbon black |
| Ex. 46 | graphite | 100 | 0.5 | 25 | 35 | 40 | 20% polyvinyl- |
| | | | | | | | pyrrolidone |
| Ex. 47 | graphite | 100 | 0.5 | 25 | 35 | 40 | 20% polyvinyl- |
| | | | | | | | pyrrolidone |
| Ex. 48 | graphite | 100 | 0.5 | 25 | 35 | 40 | 20% polyvinyl- |
| | | | | | | | pyrrolidone |
| Ex. 49 | graphite | 100 | 1.5 | 25 | 30 | 45 | 2% conductive |
| | | | | | | | carbon black |
| Ex. 50 | graphite | 100 | 1.2 | 25 | 32.5 | 42.5 | 20% glucose |
| Ex. 51 | graphite | 100 | 1.5 | 25 | 30 | 45 | 2% conductive |
| | | | | | | | carbon black |
| Ex. 52 | graphite | 100 | 1.2 | 25 | 32.5 | 42.5 | 20% glucose |
| Ex. 53 | graphite | 100 | 0.00002 | 10 | 40 | 50 | 10% polyacrylic |
| | | | | | | | alcohol |
| Ex. 54 | graphite | 100 | 0.0002 | 20 | 15 | 65 | 5% polyvinyl |
| | | | | | | | alcohol |
| Ex. 55 | graphite | 100 | 0.001 | 30 | 15 | 55 | 15% phenolic resin |
| Ex. 56 | graphite | 100 | 0.005 | 40 | 40 | 20 | 20% phenolic resin |
| Ex. 57 | graphite | 100 | 0.05 | 50 | 30 | 20 | 2% graphite sheet |
| Ex. 58 | graphite | 100 | 0.01 | 60 | 10 | 30 | 1% graphene |
| Ex. 59 | graphite | 100 | 0.00005 | 10 | 60 | 30 | 1.5% carbon |
| | | | | | | | nanotubes |
| Ex. 60 | graphite | 100 | 0.002 | 20 | 55 | 25 | 10% citric acid |
| Ex. 61 | graphite | 100 | 0.001 | 30 | 45 | 25 | 15% polyacrylic |
| | | | | | | | alcohol |
| Ex. 62 | graphite | 100 | 0.02 | 40 | 40 | 20 | 20% polyvinyl |
| | | | | | | | alcohol |
| Ex. 63 | graphite | 100 | 0.05 | 50 | 30 | 20 | 25% polyvinyl |
| | | | | | | | alcohol |
| Comparative | graphite | 100 | 0 | 0 | 25 | 75 | 20% polyvinyl- |
| Ex. 2 | | | | | | | pyrrolidone |

| | | | | | | Capacity |
|---|---|---|---|---|---|---|
| | Thickness | | | | Efficiency | retention |
| | of aluminum | Shape of | Distance* | Temperature | during the | after 500 |
| Item | foil (μm) | holes | (mm) | (° C.) | first cycles (%) | cycles(%) |
| Ex. 39 | 50 | Circle | 4 | 400 | 90 | 94 |
| Ex. 40 | 45 | Star | 3 | 500 | 89 | 93 |
| Ex. 41 | 35 | Oblique | 3 | 500 | 89.5 | 92 |
| | | diamond | | | | |
| Ex. 42 | 25 | Star | 3 | 500 | 89.5 | 91.5 |
| Ex. 43 | 25 | Circle | 3 | 500 | 88.5 | 90 |
| Ex. 44 | 60 | Star | 4 | 450 | 89 | 91.5 |
| Ex. 45 | 40 | Square | 2 | 300 | 90 | 91 |
| Ex. 46 | 25 | Square | 2 | 450 | 89.5 | 91.5 |
| Ex. 47 | 40 | Square | 2 | 450 | 89 | 92.8 |
| Ex. 48 | 30 | Regular | 2 | 450 | 89 | 92.5 |
| | | hexagon | | | | |
| Ex. 49 | 80 | Regular | 2 | 300 | 90 | 91.5 |
| | | pentagon | | | | |
| Ex. 50 | 20 | Circle | 3 | 500 | 89 | 91.5 |
| Ex. 51 | 40 | Regular | 2 | 300 | 90 | 91.5 |
| | | pentagon | | | | |
| Ex. 52 | 20 | Circle | 3 | 500 | 89 | 91.5 |
| Ex. 53 | 40 | Diamond | 0.1 | 400 | 82 | 90.1 |
| Ex. 54 | 70 | Diamond | 0.5 | 200 | 85 | 92.5 |
| Ex. 55 | 90 | Diamond | 1 | 600 | 87 | 93 |
| Ex. 56 | 40 | Diamond | 0.5 | 200 | 86 | 90 |
| Ex. 57 | 50 | Diamond | 0.5 | 250 | 87 | 90.5 |
| Ex. 58 | 100 | Diamond | 2 | 250 | 82 | 92.5 |
| Ex. 59 | 36 | Circle | 4 | 250 | 84 | 88.5 |
| Ex. 60 | 30 | Circle | 2 | 700 | 85.2 | 89.5 |
| Ex. 61 | 25 | Circle | 5 | 250 | 86.5 | 89.5 |
| Ex. 62 | 40 | Circle | 3 | 250 | 87 | 89 |
| Ex. 63 | 50 | Circle | 1 | 300 | 87.5 | 89.5 |
| Comparative | 50 | / | 0 | 400 | 75 | 87 |
| Ex. 2 | | | | | | |

(Distance* = distance between the edge of the hole and the edge of the electrode plate)

### Example 64

A method for preparing a porous aluminum foil anode comprises the following steps.

(1) A 20-micron-thick aluminum foil was made into porous aluminum foil by mechanical molding, in accordance with the design parameters including: a percentage of the area of the holes in a basic unit of 25%, a hole size of 1 mm, a circular hole, and a distance from the edge of the outermost hole and the edge of the aluminum foil of 2 mm The porous aluminum foil was then purged with compressed air to remove the burrs.

(2) Subsequently, the porous aluminum foil was immersed in an aqueous solution containing 20% polyvinylpyrrolidone for 10 minutes, and then placed in a furnace filled with an inert gas or a reducing gas and the temperature was elevated at a rate of 3° C./min to 400° C. The porous aluminum foil was subjected to carbonization at 400° C. for 4 hours to obtain a porous aluminum foil anode.

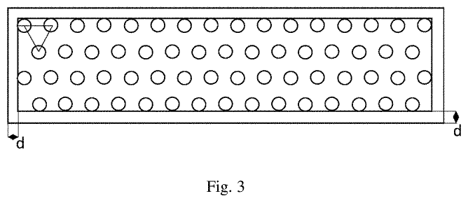

FIG. 3 shows the structure of a porous aluminum foil according to Example 64 of the present invention. In the figure, d denotes the distance between the edge of the outermost hole and the edge of the aluminum foil (2 mm); r denotes the radius of the circular hole, and an isosceles triangular region formed by connecting three centers of three adjacent holes in two adjacent rows defined a basic unit, in which the area of the holes (πr²)/2 accounts for 25% of the total area of the triangular region. In this embodiment, spacing between any two adjacent holes in a row is equal, and spacing between any two adjacent holes in a column is equal, and spacing between any two adjacent holes in a row is equal to spacing between any two adjacent rows. In other embodiments, spacing between any two adjacent holes in a row may be different from spacing between any two adjacent rows. Odd rows or columns have an equal number of holes, and even rows or columns have an equal number of holes. The holes in odd rows are aligned and equal in size, and the holes in even rows are aligned and equal in size.

While particular embodiments and aspects of the present disclosure have been illustrated and described herein, various other changes and modifications can be made without departing from the scope of the disclosure. Accordingly, it is therefore intended that the appended claims cover all such changes and modifications that are within the scope of the embodiments shown and described herein. Moreover, the terms as used herein are not intended to limit the scope of this disclosure.

1. A porous aluminum foil anode, comprising porous aluminum foil having a plurality of holes evenly arranged thereon,
wherein a triangular region formed by connecting three centers of three adjacent holes defines a basic unit, in which a percentage of the area of the holes is in a range of 10% to 79%, and
wherein a distance between an edge of the porous aluminum foil and an outermost hole is in a range of 0.1 mm to 10 mm.

2. The porous aluminum foil anode of claim 1, wherein an isosceles triangular region formed by connecting three centers of three adjacent holes in two adjacent rows defines a basic unit, and wherein percentages of the area of the holes in each basic unit are equal, and wherein the holes are equal in size.

3. The porous aluminum foil anode of claim 2, wherein spacing between any two adjacent holes in a row is equal, and wherein spacing between any two adjacent holes in a column is equal.

4. The porous aluminum foil anode of claim 3, wherein spacing between any two adjacent holes in a row is equal to spacing between any two adjacent holes in a column.

5. The porous aluminum foil anode of claim 3, wherein spacing between any two adjacent holes in a row is equal to spacing between any two adjacent rows.

6. (canceled)

7. The porous aluminum foil anode of claim 1, wherein a percentage of the area of the holes in the basic unit is in a range of 25-60%.

8. The porous aluminum foil anode of claim 1, wherein the distance between the edge of the porous aluminum foil and the outermost hole is in a range of 2 mm to 5 mm.

9. The porous aluminum foil anode of claim 1, wherein the size of the holes is in a range of 20 nm to 2 mm, and the shape of the holes comprises one or more of circle, ellipse, square, rectangle, diamond, triangle, polygon, star and trefoil.

10. The porous aluminum foil anode of claim 1, wherein a carbon material layer having a thickness of 2 nm to 5 μm is further provided on the surface of the porous aluminum foil.

11. The porous aluminum foil anode of claim 10, wherein material of the carbon material layer comprises one or more of conductive carbon black, graphene, graphite sheet, carbon nanotube, and organic carbide, and wherein the organic carbide comprises a carbide of an organic substance that is carbonized at a temperature in a range of 200° C. to 700° C.

12. A method for preparing a porous aluminum foil anode, comprising:
performing one or more processes selected from mechanical compression molding, chemical etching, laser cutting, plasma etching and electrochemical etching to obtain a porous aluminum foil and thus a porous aluminum foil anode,
wherein the porous aluminum foil has a plurality of holes evenly arranged thereon, and
wherein a triangular region formed by connecting three centers of three adjacent holes defines a basic unit, in which a percentage of the area of the holes is in a range of 10% to 79%, and
wherein a distance between an edge of the porous aluminum foil and an outermost hole is in a range of 0.1 mm to 10 mm.

13. The method of claim 12, further comprising:
preparing a carbon material layer on the porous aluminum foil, comprising:
coating a solution containing the carbon material to the surface of the porous aluminum foil, which is then dried to obtain a porous aluminum foil anode; alternatively,
coating a solution containing a precursor of the carbon material to the surface of the porous aluminum foil, which is then heat-treated in a furnace filled with an inert gas or a reducing gas for 0.5 to 6 hours to carbonize the carbon material precursor to obtain the porous aluminum foil anode.

14. A lithium secondary battery, comprising a cathode plate, an electrolyte, a separator, and an anode plate which is a porous aluminum foil anode,
wherein the porous aluminum foil anode comprises a porous aluminum foil having a plurality of holes evenly arranged thereon, and
wherein a triangular region formed by connecting three centers of three adjacent holes defines a basic unit, in which a percentage of the area of the holes is in a range of 10% to 79%, and
wherein a distance between an edge of the porous aluminum foil and an outermost hole is in a range of 0.1 mm to 10 mm, and
wherein the porous aluminum foil acts as both a current collector and an anode active material in the porous aluminum foil anode.

15. The lithium secondary battery of claim 14, wherein an isosceles triangular region formed by connecting three centers of three adjacent holes in two adjacent rows defines a basic unit, and wherein percentages of the area of the holes in each basic unit are equal, and wherein the holes are equal in size.

16. The lithium secondary battery of claim 15, wherein spacing between any two adjacent holes in a row is equal, and wherein spacing between any two adjacent holes in a column is equal.

17. The lithium secondary battery of claim 16, wherein spacing between any two adjacent holes in a row is equal to spacing between any two adjacent holes in a column.

18. The lithium secondary battery of claim 16, wherein spacing between any two adjacent holes in a row is equal to spacing between any two adjacent rows.

19. (canceled)

20. The lithium secondary battery of claim 14, wherein the size of the holes is in a range of 20 nm to 2 mm, and the shape of the holes comprises one or more of circle, ellipse, square, rectangle, diamond, triangle, polygon, star and trefoil.

21. The lithium secondary battery of claim 14, wherein a carbon material layer having a thickness of 2 nm to 5 μm is further provided on the surface of the porous aluminum foil.

22. The lithium secondary battery of claim 14, wherein 20-60% of the area of the basic unit of the porous aluminum foil is used for the current collector and 1-40% for the active material.
